(19) United States
(12) Patent Application Publication
(10) Pub. No.: US 2014/0137161 A1
(43) Pub. Date: May 15, 2014

(54) METHOD FOR SELECTING BASE STATION FOR DYNAMIC CONFIGURATION OF MOBILE IPTV SERVICE REGION IN MOBILE COMMUNICATION, SYSTEM THEREFOR, DEVICE THEREFOR, AND COMPUTER-READABLE RECORDING MEDIUM

(71) Applicant: Dae-Geun Park, Daejeon-si (KR)

(72) Inventor: Dae-Geun Park, Daejeon-si (KR)

(73) Assignee: Electronics and Telecommunications Research Institute, Daejeon (KR)

(21) Appl. No.: 14/130,432

(22) PCT Filed: Jun. 25, 2012
(86) PCT No.: PCT/KR2012/004975

§ 371 Date: Dec. 31, 2013

(30) Foreign Application Priority Data
Jul. 7, 2011 (KR) 10-2011-0067372
Dec. 1, 2011 (KR) 10-2011-0127901

(51) Int. Cl. H04N 21/61; H04N 21/643; H04N 21/41; H04N 21/414; H04N 5/44

(52) U.S. Cl. CPC H04N 21/6131; H04N 21/41407; H04N 5/4401; H04N 21/4126; H04N 21/64322
USPC 725/62

(57) ABSTRACT

Disclosed are a method for selecting a base station for dynamic configuration of a mobile IPTV service region in mobile communication, a system therefor, a device therefor, and a computer-readable recording medium. The present invention provides a method for selecting a base station for dynamic configuration of a mobile IPTV service region in mobile communication which sets up a mobile IPTV service zone by using base stations selected by a terminal to dynamically configure a mobile IPTV service region for supplying a mobile IPTV service using a multicast/broadcast method in a mobile communication network, and maintains continuous service of the mobile IPTV, a system therefor, a device therefor, and a computer-readable recording medium.

### TECHNICAL FIELD

The following description relates to a system and method for selecting a base station to dynamically configure a mobile Internet protocol television (IPTV) service area in mobile communications and an apparatus for dynamically configuring a service area. More particularly, the following description relates to a method of setting a mobile IPTV service zone using base stations selected by a terminal to dynamically configure a mobile IPTV service area and then selecting a base station maintaining the continuity of a mobile IPTV service so as to provide the mobile IPTV service using a multicast/broadcast scheme in a mobile communication network, and a system, apparatus and computer-readable recording medium for the method.

### BACKGROUND ART

The following description merely provides background information on exemplary embodiments, and does not constitute related art.

In general, a wireless communication system provides the Internet, a voice over IP (VoIP) service, a non-real-time streaming service, mobile worldwide interoperability for microwave access (WiMAX) service, wireless broadband Internet (WiBro) service, multicast broadcast service (MBS), etc. as major services. Among these services provided by wireless communication systems, the MBS is recently attracting attention as a new service. The MBS can provide a video service, such as news, dramas and sports, a data service, such as radio music broadcasting and real-time traffic information. With a high data rate based on a macro-diversity technique, the MBS can transmit various channels of high-definition video, high-quality audio, etc. at the same time.

However, a base station constituting an MBS zone should keep radio resources allocated for the MBS even if there is no MBS user in its cell. Thus, the radio resources are wasted.

### Technical Problem

The following description relates to a method of selecting a base station to dynamically configure a mobile Internet protocol television (IPTV) service area in mobile communications, whereby a member base station can be dynamically selected to configure a multicast broadcast service (MBS) zone in a mobile communication system providing an MBS using the MBS zone such that a service interruption time as well as radio resources allocated to the MBS can be reduced and a user in a poor receiving environment can also be provided with the optimum MBS, and a system, apparatus and computer-readable recording medium for the method.

### Technical Solution

In one general aspect, the present invention provides a method of selecting a base station to dynamically configure a mobile IPTV service area in a mobile communication system, includes: a connection process of connecting, at a terminal, to a mobile network through a second base station, transmitting a mobile IPTV service request signal to a service controller, and establishing a multicast connection to the second base station; a multicasting process of generating, at the service controller, a service area of a first zone including a first base station and the second base station and transmitting mobile IPTV multicast service data to the terminal, receiving, at the terminal, the mobile IPTV multicast service data through the first base station as well as the second base station, which are member base stations of the first zone, and multicasting, at the member base stations of the first zone, the data to the terminal; a terminal movement checking process of, when the terminal changes a wireless access point from the second base station to a third base station while utilizing a mobile IPTV service, transmitting, at the third base station, a movement report signal of the terminal to the service controller; a service area reconfiguration process of configuring, at the service controller, a new service area by replacing the first zone that is the previous service area with a service area of a second zone according to a report message while receiving the movement report signal of the terminal that is utilizing the mobile IPTV service, and transmitting the mobile IPTV multicast service data to the second zone that is the new service area; and a data receiving process of simultaneously receiving, at the terminal, the mobile IPTV multicast service data through the second base station and the third base station.

In another general aspect, the present invention provides a method of selecting a base station to dynamically configure a mobile IPTV service area in a mobile communication system, includes: a signal transmission process of connecting, at a terminal, to a second base station and transmitting a mobile IPTV service request signal; a service area setting process of generating, at a service controller, a service area of a first zone including the second base station and a first base station as member base stations and transmitting mobile IPTV multicast service data corresponding to the mobile IPTV service request signal to the terminal through the member base stations of the first zone; and a service area reconfiguration process of, when the service controller receives a movement report signal of the terminal that is receiving the mobile IPTV multicast service data from a third base station, configuring, at the service controller, a new service area by replacing the first zone with a service area of a second zone including the second base station and the third base station as member base stations, and transmitting the mobile IPTV multicast service data to the terminal through the member base stations of the second zone.

In still another general aspect, the present invention provides a computer-readable recording medium storing a program for implementing: a connection process of connecting, at a terminal, to a mobile network through a second base station, transmitting a mobile IPTV service request signal to a service controller, and establishing a multicast connection to the second base station; a multicasting process of generating, at the service controller, a service area of a first zone including a first base station and the second base station and transmitting mobile IPTV multicast service data to the terminal, receiving, at the terminal, the mobile IPTV multicast service data through the first base station as well as the second base station, which are member base stations of the first zone, and multicasting, at the member base stations of the first zone, the data to the terminal; a terminal movement checking process of, when the terminal changes a wireless access point from the second base station to a third base station while utilizing a mobile IPTV service, transmitting, at the third base station, a movement report signal of the terminal to the service controller; a service area reconfiguration process of configuring, at the service controller, a new service area by replacing the first zone that is the previous service area with a service area of a second zone according to a report message while receiving the movement report signal of the terminal that is utilizing the mobile IPTV service, and transmitting the mobile IPTV multicast service data to the second zone that is the new service area; and a data receiving process of simultaneously receiving, at the terminal, the mobile IPTV multicast service data through the second base station and the third base station.

In yet another general aspect, the present invention provides a system for selecting a base station to dynamically configure a mobile IPTV service area in a mobile communication system, includes: a terminal configured to connect to a mobile network through a second base station, transmit a mobile IPTV service request signal, and establish a multicast connection to the second base station; a gateway configured to set a data path by interoperating with the second base station, and allocate a multicast channel; and a service controller configured to generate a service area of a first zone including a first base station and the second base station, transmit mobile IPTV multicast service data to the terminal, and when a movement report signal of the terminal that is receiving the mobile IPTV multicast service data is received from a third base station, configure a new service area by replacing the first zone that is the previous service area with a service area of a second zone according to a report message and transmit the mobile IPTV multicast service data to the terminal through the second zone that is the new service area.

In yet another general aspect, the present invention provides a system for selecting a base station to dynamically configure a mobile IPTV service area in a mobile communication system, includes: a terminal configured to connect to a second base station and transmit a mobile IPTV service request signal; and a service controller configured to generate a service area of a first zone including the second base station and a first base station as member base stations, transmit mobile IPTV multicast service data corresponding to the mobile IPTV service request signal to the terminal through the member base stations of the first zone, and when a movement report signal of the terminal that is receiving the mobile IPTV multicast service data is received from a third base station, configure a new service area by replacing the first zone with a service area of a second zone including the second base station and the third base station as member base stations, and transmit the mobile IPTV multicast service data to the terminal through the member base stations of the second zone.

In yet another general aspect, the present invention provides an apparatus for dynamically configuring a service area, includes: a signal receiver configured to receive a mobile IPTV service request signal from a terminal connected to a second base station; a service area setter configured to generate a service area of a first zone including the second base station and a first base station as member base stations, and cause mobile IPTV multicast service data corresponding to the mobile IPTV service request signal to be transmitted to the terminal through the member base stations of the first zone; a mobility determiner configured to receive a movement report signal of the terminal that is receiving the mobile IPTV multicast service data from a third base station; and a service area reconfigurator configured to, when the movement report signal is received, configure a new service area by replacing the first zone with a service area of a second zone including the second base station and the third base station as member base stations, and cause the mobile IPTV multicast service data to be transmitted to the terminal through the member base stations of the second zone.

Additional features of the invention will be set forth in the description which follows, and in part will be apparent from the description, or may be learned by practice of the invention.

### Advantageous Effects

As described above, in exemplary embodiments, a user measures (scans) signals sent by surrounding base stations and selects a surrounding base station that is transmitting the best signal as a member base station for an MBS, such that the user can be provided with an optimum quality of MBS even after an MBS zone is configured.

Also, in exemplary embodiments of the present invention, signals of surrounding base stations are measured, and only a predetermined number of base stations are selected as member base stations and constitute an MBS zone, such that the amount of radio resources required for maintaining the MBS zone can be minimized, and the MBS zone can be configured before a handover (in which a user moves from one cell to another cell) by periodically measuring signals of surrounding base stations and newly configuring an MBS zone at every measurement time.

Furthermore, in exemplary embodiments of the present invention, surrounding base station scan information required for a handover of a user is used as MBS zone configuration information. Since there is a very high probability that a target cell to which the user moves upon the handover will be one of cells included in a previously configured MBS zone (i.e., there is a high probability that the cell to which the user will move is an MBS zone providing the same service as the previously configured current MBS zone), the handover is the same as movement of the user in the same MBS zone. For this reason, an MBS interruption time is much shorter than an MBS interruption time caused by a handover between different MBS zones or a handover to a cell outside an MBS zone.

### DESCRIPTION OF DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic diagram showing a constitution of a system for selecting a base station to dynamically configure a mobile Internet protocol television (IPTV) service area according to an exemplary embodiment.

FIG. 2 is a schematic block diagram of an apparatus for dynamically configuring a service area according to an exemplary embodiment.

FIG. 3 is a flowchart illustrating a method of dynamically configuring a service area upon subscription to a mobile IPTV service according to an exemplary embodiment.

FIG. 4 is a flowchart illustrating a method of dynamically configuring a service area upon withdrawal from a mobile IPTV service according to an exemplary embodiment.

FIG. 5 is a flowchart illustrating configuration, change and release of a mobile IPTV service area according to an exemplary embodiment.

FIG. 6 is a flowchart illustrating a method of selecting a base station to dynamically configure a mobile IPTV service area according to an exemplary embodiment.

### MODE FOR INVENTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

Before the detailed description of exemplary embodiments, certain technologies will be mentioned in order to aid in understanding the exemplary embodiments. The technologies mentioned below are not limited to those of the exemplary embodiments, and are works of reference to aid in understanding the technologies of the exemplary embodiments.

In standard specifications such as Institute of Electrical and Electronics Engineers (IEEE) 802.16e, IEEE802.16m, Third Generation Partnership Project (3GPP)/Long Term Evolution (LTE), and World Interoperability for Microwave Access (WiMAX) forum, services based on multicast or broadcast channels (referred to as multicast broadcast service (MBS)) in a mobile network have been proposed under names such as MBS, enhanced-MBS (E-MBS), multicast broadcast multimedia service (MBMS), enhanced-MBMS (E-MBMS), MultiCast BroadCast Service (MCBCS), and so on.

Here, broadcast is a communication scheme for transmitting a packet to an entire network to which a broadcasting host belongs. Broadcast is a transmission to all network equipment in a local area network (LAN), in which “local” means a space divided by a router, that is, a space referred to as a broadcast domain. Broadcast is a necessary communication scheme, but an unnecessary interrupt occurs because data is also transmitted to hosts that do not need to receive the data. Also, broadcast is limited to a network to which a broadcasting host belongs, and is not performed via a router. In addition, multicast is a scheme for at least one transmitting person to transmit data to at least one specific receiving person. In the case of multicast, it is possible to send data to specific hosts that want to receive the data, but the function needs to be supported by a switch or router.

MBS will be described in further detail. In IEEE802.16e/IEEE802.16m (referred to as IEEE802.16 below), a plurality of base stations are defined as one broadcasting service area, that is, an MBS zone or E-MBS zone, which is used as a service unit for providing an MBS. An MBS zone proposed in IEEE 802.16 is fixedly set by a network administrator, and information on the MBS zone is managed by a service controller that serves as a broadcasting server. A service using such a static MBS zone has advantages in that a user can be provided with a better quality of MBS even in an environment with poor signal reception, such as a cell boundary, because a terminal repeatedly receives the same signal sent by base stations (member base stations) providing the MBS. Such an effect is referred to as a macro-diversity effect.

On the other hand, all base stations (member base stations) constituting an MBS zone need to keep radio resources allocated for the MBS even if there is no MBS user in their cells. Thus, the radio resources are wasted. Also, the larger the MBS zone, that is, the greater the number of member base stations, the better the quality of receiving an MBS signal, but the amount of wasted radio resources increases as well.

To solve this problem of a static MBS zone, the following technologies have been disclosed. A document entitled “Semi-static and dynamic SFN areas for MBMS services, October 10” submitted in a Third Generation Partnership Project (3GPP) technical specification group (TSG) radio access network (RAN) working group 3 (WG3) meeting proposes configuration of semi-static and dynamic MBS zones considering that the density and distribution of users who use an MBS in a static MBS zone (an MBS zone is defined as a multicast broadcast multimedia service (MBMS) service area in the document) vary considerably according to time. In a semi-static service area setting scheme, an operation and maintenance (O&M) sets MBMS areas differently according to parameters that can be specialized for some schedules or services.

However, since a time for a user to utilize the service, a place where the user utilizes the service, etc. are not fixed, it may be difficult to provide the service using such a method according to circumstances or to provide an appropriate quality of service. Another method proposed in the document is dynamic MBS zone setting. In this method, the service is provided to a place where a user is present only when the user utilizes the service, thereby lessening restrictions on cell design while optimizing resource use. However, when the user moves out of a dynamically set MBS zone and enters a cell to which the service is not provided, it is difficult to use the service, or the service may be interrupted until the service is connected again. Although not mentioned in the document, when only cell areas in which users of the service are present are configured as an MBS zone, and the density of the users of the service is low or the users are gathered in a specific cell only, the MBS zone consists of an excessively small number of cells, and users present at a cell boundary or in a place having an environment with poor signal reception cannot obtain the macro-diversity effect.

Meanwhile, a paper entitled “Location Management Area (LMA)-based MBS Handover in Mobile WiMAX Systems” proposes a method of dividing an entire static MBS zone into some areas referred to as LMAs and then causing only LMAs in which terminals wanting the MBS to participate in the MBS. This method has an advantage in that it is possible to reduce the amount of used radio resources of base stations that do not belong to the MBS zone by causing not all base stations in the MBS zone but only base stations belonging to the LMAs to participate in the MBS. In this method, an MBS zone is divided into other static service areas (LMAs), and when a user moves to a new LMA to which the service is not provided, a service interruption may occur. Also, when the size of an LMA is small, movement frequently occurs between LMAs, and service boundary areas increase, which may deteriorate MBS quality. On the other hand, when the size of an LMA becomes large, performance deteriorates in terms of resource use, which is a similar problem to that of an existing static MBS zone.

As described above, the method of setting a fixed MBS zone has a problem in that member base stations which do not provide the MBS also need to allocate radio resources, and the method of setting a semi-static MBS zone has a problem in that it is difficult to provide a user with a stable service because it is difficult to appropriately reflect a time, location, etc. at which the user utilizes the MBS at the right time. Also, the method of dynamically setting an MBS zone in which the MBS zone is set around a place where a user is present has a problem in that when the MBS user moves out of the set MBS zone, it is impossible to use the MBS, or the MBS is interrupted until the service is connected again, and a problem in that when the MBS zone is configured excessively small, the quality of the MBS received by a user at a cell boundary or in an environment with poor signal reception may deteriorate.

Accordingly, exemplary embodiments describe a system structure and method for dynamically selecting an appropriate number of member base stations to reduce waste of radio resources and service interruption time between MBS zones, and provide a high-quality MBS.

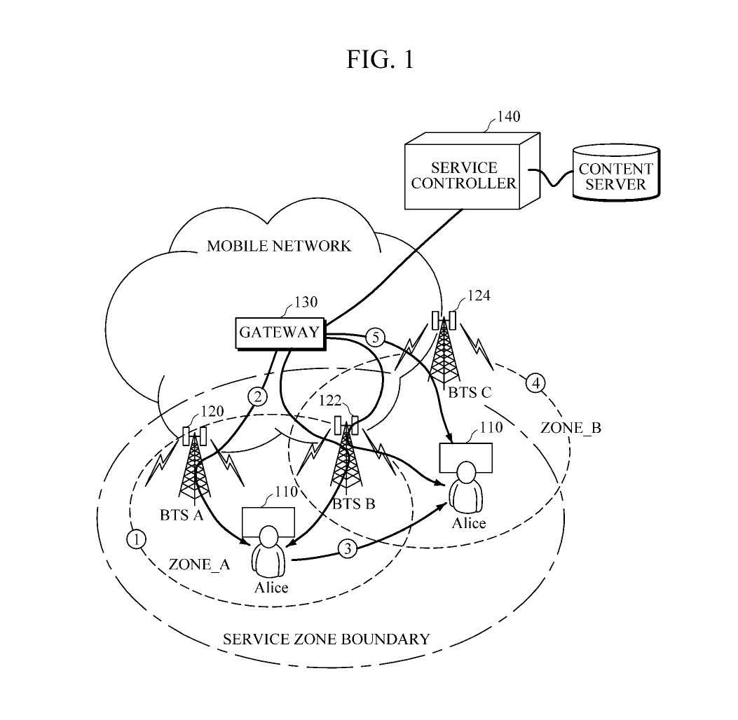

FIG. 1 is a schematic diagram showing a constitution of a system for selecting a base station to dynamically configure a mobile Internet protocol television (IPTV) service area according to an exemplary embodiment.

A system for selecting a base station to dynamically configure a mobile IPTV service area according to this exemplary embodiment includes a terminal 110, base station A 120, base station B 122, base station C 124, gateway 130, and a service controller 140. In this exemplary embodiment, the system for selecting a base station to dynamically configure a mobile IPTV service area only includes the terminal 110, base station A 120, base station B 122, base station C 124, the gateway 130, and the service controller 140, but this constitution is merely an example of the spirit of this exemplary embodiment. Those of ordinary skill in the art will be able to diversely change and modify components included in the system for selecting a base station to dynamically configure a mobile IPTV service area without departing from the basic spirit of this exemplary embodiment.

The constitution of a system proposed in this exemplary embodiment to which a method of configuring an MBS zone by dynamically selecting member base stations is applied is as shown in FIG. 1. As shown in FIG. 1, a service zone denotes an MBS zone (referred to as a “service zone” below).

Such a service zone is a service area to which a multicast service is provided, and includes at least one base station (e.g., base station A 120, base station B 122, and base station C 124) referred to as a member base station. Such a service zone is newly configured every time a user subscribes to/withdraws from a new mobile IPTV service (which is the same as an MBS, but will be referred to as “mobile IPTV service” below for convenience) or a handover which entails changing a base station to which a user is connected occurs, and is generated/changed/removed at predetermined time intervals.

In other words, a service zone is configured when a user who subscribes to a mobile IPTV service requests the service, and is removed when the last user who has used the mobile IPTV service moves out of the service zone. Also, member base stations of a service zone are changed every time the terminal 110 measures the strength (received signal strength indicators (RSSIs)) or quality (signal-to-interference plus noise ratios (SINRs)) of signals sent by surrounding base stations, selects candidate member base stations, and then sends the corresponding information to the service controller 140 to request setting and change of the service zone. The service zone boundary of a mobile IPTV service is a group of all base stations capable of participating in a multicast service, and is designed in consideration of content synchronization among the base stations. Also, a service zone consists of base stations in a multicast transmission region.

Specifically, a service zone stated in this exemplary embodiment may be classified into zone A and zone B. Member base stations corresponding to zone A may include base station B 122 and base station A 120, and those corresponding to zone B may include base station C 124 and base station B 122.

The terminal 110 indicates a terminal that can transmit and receive various types of data via a mobile network according to key manipulation of a user, and may be any one among a tablet personal computer (PC), a laptop computer, a PC, a smart phone, a personal digital assistant (PDA), a mobile communication terminal, and so on. Also, the terminal 110 may be a cloud computing terminal that supports cloud computing whereby services, such as a data reading, writing and storage service, a network service, and a content service, can be used via a mobile network.

Specifically, the terminal 110 is a terminal that can receive content from a content server via base station A 120, base station B 122, base station C 124, the gateway 130, and the service controller 140 in an MBS scheme, and includes a memory for storing a program or protocol for communicating with the content server via base station A 120, base station B 122, base station C 124, the gateway 130, and the service controller 140, a microprocessor for executing the program and performing a calculation and control, and so on. In other words, the terminal 110 can be any terminal capable of server-client communication, which includes all communication computing apparatuses such as a notebook computer, a mobile communication terminal, and a PDA.

The terminal 110 runs a mobile IPTV application for receiving a mobile IPTV service by manipulation or instructions of the user, and may play content received from the content server through the mobile IPTV application using the MBS scheme. Such a mobile IPTV application will be described in further detail. When the terminal 110 is a smart phone, the mobile IPTV application indicates an application downloaded through an application store and then installed. When the terminal 110 is a feature phone, the mobile IPTV application indicates an application run on a virtual machine (VM) downloaded through the server of a communication service provider.

The terminal 110 receives an MBS signal sent by an interoperating base station (i.e., one of base station A 120, base station B 122, and base station C 124) using multicast channel information of the base station. Also, the terminal 110 receives wireless signals sent by base stations around a current location and measures the strength (RSSIs) or quality (SINRs) of the wireless signals. At this time, the terminal 110 may select a predetermined number of base stations in order of decreasing strength of the signals or decreasing quality of the signals and a base station connected with the terminal 110 itself as candidate member base stations of an MBS zone. The terminal 110 needs to send candidate member base station information for configuring the corresponding service zone to the service controller 140 when subscribing to an MBS, immediately after performing a handover, and at predetermined time intervals after candidate member base stations of the zone are selected. Meanwhile, upon a handover, the terminal 110 may select one of service zone member base stations on a target cell candidate list as a target cell with reference to a list of the candidate member base stations in the service zone.

The terminal 110 according to this exemplary embodiment connects to the mobile network via base station B 122, transmits a mobile IPTV service request signal to the service controller 140, and establishes a multicast connection to base station B 122. Here, the terminal 110 receives mobile IPTV multicast service data via base station A 120 as well as base station B 122, which are member base stations of zone A. Meanwhile, “Alice” shown in FIG. 1 may be used as an identifier of the terminal 110.

Operation of the terminal 110 in zone A before movement is as follows. In zone A before movement, the terminal 110 measures an ambient electromagnetic wave environment and transmits a candidate member base station list selected on the basis of information on the measured ambient electromagnetic wave environment to the service controller 140. Also, the terminal 110 receives mobile IPTV multicast service data from all base stations (base station A 120 and base station B 122) corresponding to member base stations of zone A.

Operation of the terminal 110 in zone B after movement is as follows. When the terminal 110 changes a wireless access point from base station B 122 to base station C 124 while utilizing the mobile IPTV service, base station C 124 transmits a movement report signal of the terminal 110 to the service controller 140. In zone B after movement, the terminal 110 measures an ambient electromagnetic wave environment and transmits a candidate member base station list selected on the basis of information on the measured ambient electromagnetic wave environment to the service controller 140. The terminal 110 simultaneously receives mobile IPTV multicast service data from base station B 122 and base station C 124 corresponding to member base stations of zone B.

Base station A 120, base station B 122 and base station C 124 perform all functions required for wireless call processing such as a location registration function, a function of allocating a radio channel, and a handoff function. In other words, base station A 120, base station B 122 and base station C 124 interoperate with the terminal 110 through a traffic channel among signal channels, and are directly connected with the terminal 110 by performing baseband signal processing, wireless/wired conversion, wireless signal transmission and reception, and so on. Also, base station A 120, base station B 122 and base station C 124 perform functions of radio channel allocation and release, transmission output control, inter-cell soft handoff and hard handover determination, transcoding and vocoding, global positioning system (GPS) clock distribution, base station administration and maintenance, etc. for the terminal 110.

Base station A 120, base station B 122 and base station C 124 reserve multicast channels to be used for data transfer according to synchronization information of the gateway 130, periodically broadcast information on the multicast channels into their cell areas, and manage data path connections with the gateway 130. Also, base station A 120, base station B 122 and base station C 124 reserve multicast channels to be used for data transfer according to the synchronization information of the gateway 130. At this time, base station A 120, base station B 122 and base station C 124 periodically transmit the information on the multicast data channels into their cell areas, manage the data path connections with the gateway 130, and transmit data into their cell areas.

Specifically, when the terminal 110 is present in zone A, the member base stations of zone A (base station A 120 and base station B 122) multicast data to the terminal 110, and when the terminal 110 is present in zone B, the member base stations of zone B (base station B 122 and base station C 124) multicast data to the terminal 110.

The gateway 130 manages a data path connection with the service controller 140, transfers data to the corresponding member base station of a service zone, performs a tunneling function for data transfer with base station A 120, base station B 122 and base station C 124, and adjusts a transmission time point of a data frame to synchronize transmission data among base stations belonging to the same service zone.

The gateway 130 may adjust a transmission time point of a data frame to synchronize transmission data among base stations belonging to the same service zone. In other words, the gateway 130 periodically transmits synchronization information to member base stations, and performs the tunneling function for data transfer between a base station and the gateway 130. At this time, the gateway 130 manages the data path connection with the service controller 140, and transfers data to member base stations of a service zone. Also, every time the generation/change/removal of a service zone is reported, the gateway 130 may control transmission of synchronization information sent to the relevant member base stations.

When a new setting notification message about zone A is received from the service controller 140, the gateway 130 according to this exemplary embodiment transmits a message about synchronization rules and a message for a data path setting request to the member base stations (base station A 120 and base station B 122) of zone A corresponding to the new notification message, thereby setting data paths with the member base stations (base station A 120 and base station B 122) and allocating multicast channels according to the synchronization rules. Meanwhile, when a new setting notification message about zone B is received from the service controller 140, the gateway 130 transmits a message about synchronization rules and a message for a data path setting request to the member base stations (base station B 122 and base station C 124) corresponding to the new notification message about zone B, thereby setting data paths with the member base stations (base station B 122 and base station C 124) and allocating multicast channels according to the synchronization rules.

The mobile network shown in FIG. 1 includes base station A 120, base station B 122, base station C 124, and the gateway 130, and refers to a network, such as the Internet, an intranet, a mobile communication network, and a satellite communication network, that can transmit and receive data using various wireless/wired communication technologies and an Internet protocol. Also, the mobile network may include a cloud computing network that can store computing resources, such as hardware and software, and provide computing resources required by a client to the terminal 110 in combination with the service controller 140. Here, cloud computing denotes a computing environment in which information is permanently stored in a server on the Internet and temporarily stored in a client terminal, such as a desktop computer, tablet computer, notebook computer, netbook computer, and smart phone. Also, cloud computing denotes a computer environment access network in which all information of a user is stored in a server on the Internet and can be used through various information technology (IT) devices anytime anywhere.

In addition, such a mobile network may not be only a closed network, such as a LAN or wide area network (WAN), or an open network, such as the Internet, but may also be a network, such as a code division multiple access (CDMA) network, wideband CDMA (WCDMA) network, global system for mobile communications (GSM) network, long term evolution (LTE) network, or evolved packet core (EPC) network, or a next-generation network to be implemented in the future.

The service controller 140 manages configuration of a mobile IPTV service area, a multicast group, a user/service profile, and a parameter for transferring multicast data in a wireless section, and transmits service information, such as an electronic program guide (EPG) or electronic content guide (ECG) to the terminal 110 that utilizes the mobile IPTV service.

As generation operation, the service controller 140 manages the configuration of a service zone, a multicast group, a user/service profile, and a channel parameter for transferring multicast data in a wireless section. Also, the service controller 140 transmits service information, such as an EPG or ECG to the terminal 110, manages a service and data path connection between the service controller 140 and the gateway 130, and also transfers service data provided by the content server to the terminal 110.

The service controller 140 constructs and manages a zone information table storing information on dynamically varying member base stations and a service zone consisting of the member base stations. Here, the information table includes at least one kind of information among a service zone identifier, an identifier of a member base station, an identifier of a service user, and a channel parameter for the mobile IPTV service.

In addition, member base station information on a service zone that is most recently set by each user of each mobile IPTV service needs to be included, and the number of users of each mobile IPTV service needs to be maintained according to member base stations of the service zone. Details of a service zone information table are as shown in [Table 1] and [Table 2].

TABLE 1

| User | Mobile IPTV | List of Member Base Stations in User Setting |
|---|---|---|
| Identifier | Identifier | Mobile IPTV Zone |
| Alice | MBS_α | [BTS_A, BTS_C, BTS_E, BTS_G, BTS_I] |
| . | . | . |
| . | . | . |
| . | . | . |
| Tom | MBS_Ω | [BTS_E, BTS_G, BTS_I, BTS_K, BTS_M] |

TABLE 2

| Mobile | Number of Mobile | | | |
|---|---|---|---|---|
| IPTV Service | IPTV Users of Mobile IPTV Zone Member | | | |
| Identifier | Base Station (Based on Service) [Base Station Identifier] | | | |
| MBS_α | 2(BTS_A) | 3(BTS_C) | . . . | 0(BTS_X) |
| . | . | . | . . . | . |
| . | . | . | | . |
| . | . | . | | . |
| MBS_Ω | 5(BTS_E) | 5(BTS_G) | . . . | 2(BTS_Z) |

Further, the service controller 140 needs to be able to select only base stations included in a service zone range of a mobile IPTV service from a candidate member base station list sent by a user as actual candidate member base stations according to predetermined standards for selecting member base stations.

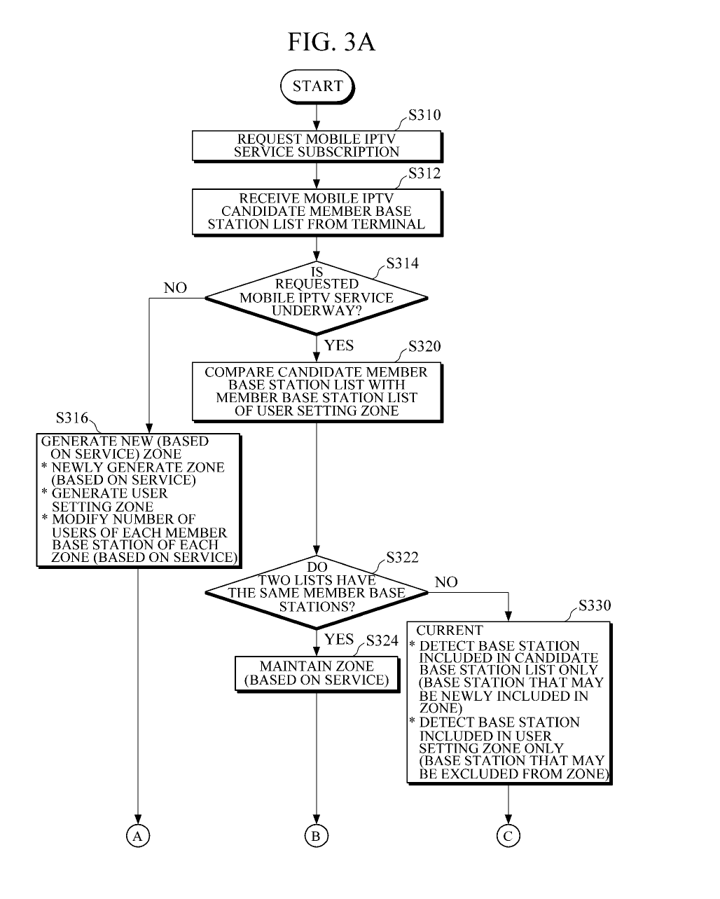

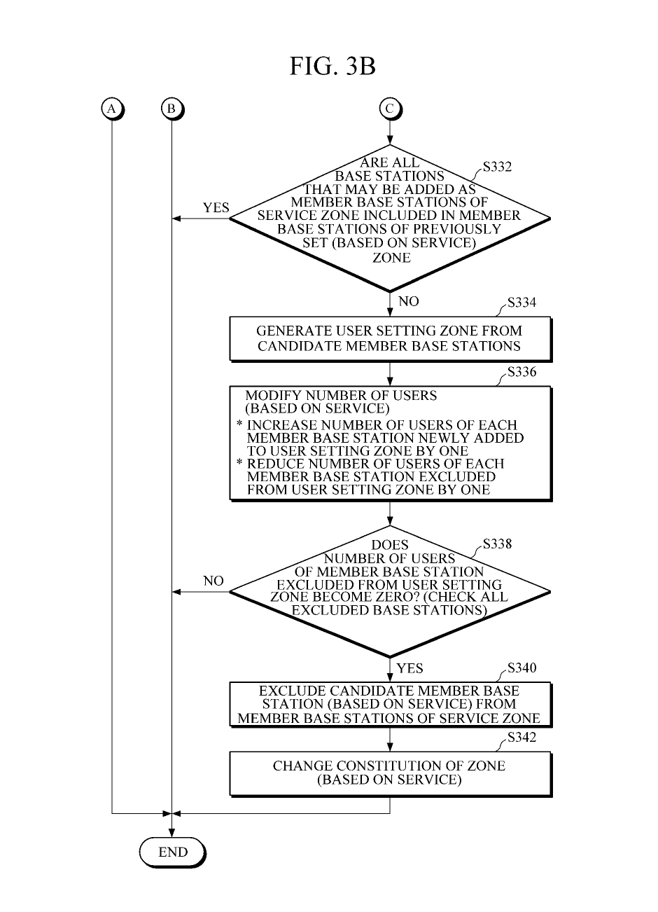

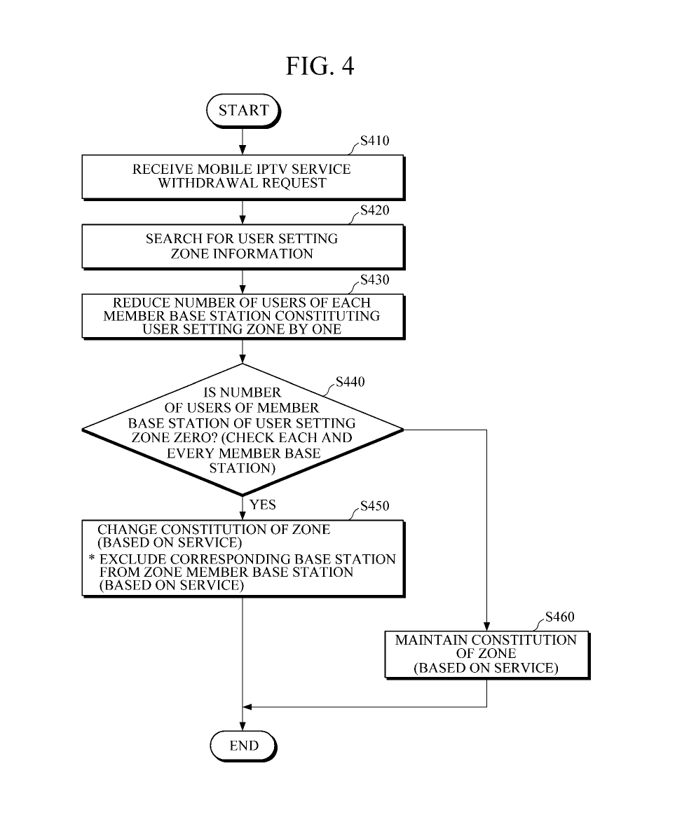

Moreover, the service controller 140 may generate/modify/remove a service zone every time a user subscribes to/withdraws from a mobile IPTV service, or a mobile IPTV service member base station list sent by a user is received. Operation for the service controller 140 to generate a service zone is as follows. The service controller 140 determines to generate a service zone when an initial subscription request for a specific mobile IPTV service is received from a mobile IPTV service user, and generates a service zone when a first candidate member base station list is received after the service subscription request. Operation for the service controller 140 to remove a service zone may be performed when the last user subscribing to a mobile IPTV service requests withdrawal from the mobile IPTV service. Change of a service zone may be performed when the service controller 140 compares information on candidate member base stations transmitted by a user of a mobile IPTV service with information on currently set mobile IPTV service zone member base stations. At this time, if the two pieces of information are the same, the constitution of the mobile IPTV service zone does not need to be changed. Also, the service controller 140 registers base stations included in a candidate member base station list only as new member base stations, but a base station included in only an information table of a mobile IPTV service can be excluded from member base stations only when there is no user who receives the mobile IPTV service through the base station. Detailed procedures of such a service zone management algorithm of the service controller 140 will be described with reference to FIGS. 3 and 4. Every time such a service zone is generated/changed/removed, the service controller 140 reports information on a relevant member base station and channel parameter information for a mobile IPTV service to the gateway 130.

The service controller 140 according to this exemplary embodiment generates a service area of zone A including base station A 120 and base station B 122, and then transmits mobile IPTV multicast service data to the terminal 110. While receiving a movement report signal of the terminal 110 that is utilizing a mobile IPTV service, the service controller 140 configures a new service area by replacing a previous service area of zone A with a service area of zone B according to a report message, and then transmits mobile IPTV multicast service data to zone B that is the new service area. Meanwhile, when a subscription request signal for a mobile IPTV service is received from the terminal 110, the service controller 140 determines whether or not the terminal 110 has subscribed to the mobile IPTV service on the basis of service profile information received from an authentication apparatus (e.g., authentication, authorization and accounting (AAA)), and transmits a subscription response signal to the terminal 110 on the basis of the determination result.

Operation of the service controller 140 when the terminal 110 is in zone A before movement will be described below. The service controller 140 sets zone A, which is a service area, on the basis of a candidate member base station list received from the terminal 110 and predetermined reference information. At this time, the service controller 140 selects an optimum candidate base station from the candidate member base station list, and generates an information table for managing zone A. Here, the information table includes at least one kind of information among identifier information on zone A, identifier information on member base stations of zone A, user identifier information, and channel parameter information used in zone A. Also, the service controller 140 transmits a new setting notification message about zone A to the gateway 130. Here, the new setting notification message includes at least one kind of information among identifiers of the member base stations of zone A and channel parameter information for transferring data in a zone. The service controller 140 distributes mobile IPTV multicast service data to the gateway 130. When the mobile IPTV multicast service data is received through the gateway 130, the mobile IPTV multicast service data is distributed to the respective member base stations (base station A 120 and base station B 122) of zone A, and transmitted to the corresponding cell area through the member base stations.

Operation of the service controller 140 when the terminal 110 is in zone B after movement will be described below. The service controller 140 compares ambient electromagnetic wave environment information received from the terminal 110 which has changed a wireless access point with a candidate member base station list received from the terminal 110, and adds a new member base station to an information table or excludes a member base station that is not included in the candidate member base station list from the information table. At this time, the service controller 140 transmits a new setting notification message about zone B to the gateway 130. Also, the service controller 140 distributes mobile IPTV multicast service data to the gateway 130. When the mobile IPTV multicast service data is received through the gateway 130, the mobile IPTV multicast service data is distributed to the respective member base stations (base station B 122 and base station C 124) of zone B, and transmitted to the corresponding cell area through the member base stations (base station B 122 and base station C 124) of zone B.

An operation of determining whether or not to maintain a service area among operations of the service controller 140 will be described below. When a mobile IPTV service request signal is received from the terminal 110 connected through base station B 122, the service controller 140 generates a service area of zone A including base station B 122 and base station A 120 as member base stations, and then transmits mobile IPTV multicast service data corresponding to the mobile IPTV service request signal to the terminal 110 through the member base stations of zone A. Here, when the terminal 110 performs a handover from base station B 122 to base station C 124, the service controller 140 receives a movement report signal of the terminal 110 that is receiving mobile IPTV multicast service data from base station C 124, configures a new service area by replacing zone A with zone B including base station B 122 and base station C 124 as member base stations, and then transmits mobile IPTV multicast service data to the terminal 110 through a member base station of zone B. In this process, the service controller 140 determines whether or not to maintain zone A on the basis of the number of terminals 110 that are connected to base station B 122 and receiving mobile IPTV multicast service data. More specifically, the service controller 140 may maintain zone A when the number of terminals 110 that are connected to base station B 122 and receiving mobile IPTV multicast service data is not zero, and may not maintain but remove zone A when the number of terminals 110 that are connected to base station B 122 and receiving mobile IPTV multicast service data is zero.

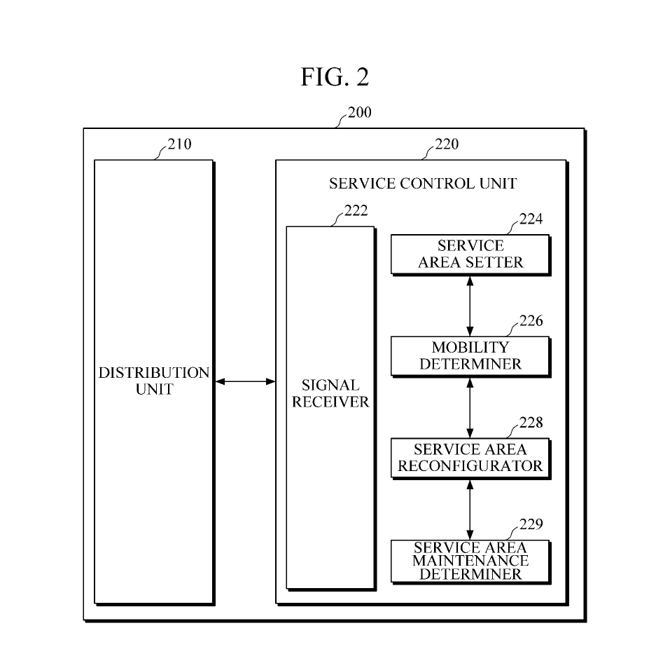

FIG. 2 is a schematic block diagram of an apparatus for dynamically configuring a service area according to an exemplary embodiment.

An apparatus 200 for dynamically configuring a service area according to this exemplary embodiment includes a distribution unit 210 and a service control unit 220. In this exemplary embodiment, the apparatus 200 for dynamically configuring a service area includes the distribution unit 210 and the service control unit 220 only, but this constitution is merely an example of the spirit of this exemplary embodiment. Those of ordinary skill in the art will be able to diversely change and modify components included in the apparatus 200 for dynamically configuring a service area without departing from the basic spirit of this exemplary embodiment.

Meanwhile, the apparatus 200 for dynamically configuring a service area illustrated in FIG. 2 will be described on the assumption that the gateway 130 and the service controller 140 shown in FIG. 1 are implemented as one apparatus. In other words, in this exemplary embodiment, the gateway 130 may be incorporated into the distribution unit 210, and the service controller 140 may be incorporated into the service control unit 220.

The distribution unit 210 manages a data path connection with the service control unit 220, transfers data to the corresponding member base station of a service zone, performs the tunneling function for data transfer with base station A 120, base station B 122 and base station C 124, and adjusts a transmission time point of a data frame to synchronize transmission data among base stations belonging to the same service zone.

When a new setting notification message about zone A is received from the service control unit 220, the distribution unit 210 according to this exemplary embodiment transmits a message about synchronization rules and a message for a data path setting request to the member base stations (base station A 120 and base station B 122) of zone A corresponding to the new notification message, thereby setting data paths with the member base stations (base station A 120 and base station B 122) and allocating multicast channels according to the synchronization rules. Meanwhile, when a new setting notification message about zone B is received from the service control unit 220, the distribution unit 210 transmits a message about synchronization rules and a message for a data path setting request to the member base stations (base station B 122 and base station C 124) corresponding to the new notification message about zone B, thereby setting data paths with the member base stations (base station B 122 and base station C 124) and allocating multicast channels according to the synchronization rules.

The service control unit 220 according to this exemplary embodiment generates a service area of zone A including base station A 120 and base station B 122, and then transmits mobile IPTV multicast service data to the terminal 110. While receiving a movement report signal of the terminal 110 that is utilizing a mobile IPTV service, the service control unit 220 configures a new service area by replacing a previous service area of zone A with a service area of zone B according to a report message, and then transmits mobile IPTV multicast service data to zone B that is the new service area. Meanwhile, when a subscription request signal for a mobile IPTV service is received from the terminal 110, the service control unit 220 determines whether or not the terminal 110 has subscribed to the mobile IPTV service on the basis of service profile information received from an authentication apparatus (e.g., AAA), and transmits a subscription response signal to the terminal 110 on the basis of the determination result.

Operation of the service control unit 220 when the terminal 110 is in zone A before movement will be described below. The service control unit 220 sets zone A, which is a service area, on the basis of a candidate member base station list received from the terminal 110 and predetermined reference information. At this time, the service controller 140 selects an optimum candidate base station from the candidate member base station list, and generates an information table for managing zone A. Here, the information table includes at least one kind of information among identifier information on zone A, identifier information on member base stations of zone A, user identifier information, and channel parameter information used in zone A. Also, the service control unit 220 transmits a new setting notification message about zone A to the distribution unit 210. Here, the new setting notification message includes at least one kind of information among identifiers of the member base stations of zone A and channel parameter information for transferring data in a zone. The service control unit 220 distributes mobile IPTV multicast service data to the distribution unit 210. When the mobile IPTV multicast service data is received through the distribution unit 210, the mobile IPTV multicast service data is distributed to the respective member base stations (base station A 120 and base station B 122) of zone A, and transmitted to the corresponding cell area through the member base stations.

Operation of the service control unit 220 when the terminal 110 is in zone B after movement will be described below. The service control unit 220 compares ambient electromagnetic wave environment information received from the terminal 110 which has changed a wireless access point with a candidate member base station list received from the terminal 110, and adds a new member base station to an information table or excludes a member base station that is not included in the candidate member base station list from the information table. At this time, the service control unit 220 transmits a new setting notification message about zone B to the distribution unit 210. Also, the service control unit 220 distributes mobile IPTV multicast service data to the distribution unit 210. When the mobile IPTV multicast service data is received through the distribution unit 210, the mobile IPTV multicast service data is distributed to the respective member base stations (base station B 122 and base station C 124) of zone B, and transmitted to the corresponding cell area through the member base stations (base station B 122 and base station C 124) of zone B.

Meanwhile, the service control unit 220 may include a signal receiver 222, a service area setter 224, a mobility determiner 226, a service area reconfigurator 228, and a service area maintenance determiner 229.

Each module included in the service control unit 220 will be described below. The signal receiver 222 receives a mobile IPTV service request signal from the terminal 110 connected to base station B 122. The service area setter 224 generates a service area of zone A including base station B 122 and base station A 120 as member base stations, and then controls mobile IPTV multicast service data corresponding to the mobile IPTV service request signal received from the terminal connected through base station B 122 to be transmitted to the terminal 110 through the member base stations of zone A (base station A 120 and base station B 122).

The mobility determiner 226 checks whether or not a movement report signal of the terminal 110 that is receiving the mobile IPTV multicast service data is received from base station C 124 that is outside of zone A connected with the terminal 110.

When the movement report signal of the terminal 110 that is receiving the mobile IPTV multicast service data is received through the mobility determiner 226, the service area reconfigurator 228 configures a new service area by replacing zone A with a service area of zone B including base station B 122 and base station C 124 as member base stations, and then controls mobile IPTV multicast service data to be transmitted to the terminal 110 through the member base stations of zone B (base station B 122 and base station C 124).

Since a service area for the terminal 110 is changed from zone A to zone B, the service area maintenance determiner 229 operates as follows to determine whether or not to maintain zone A. Specifically, the service area maintenance determiner 229 determines whether or not to maintain zone A on the basis of the number of terminals that are connected to base station B 122 and receiving mobile IPTV multicast service data. The service controller 140 maintains zone A when the number of terminals that are connected to base station B 122 and receiving mobile IPTV multicast service data is not zero, and does not maintain but removes zone A when the number of terminals that are connected to base station B 122 and receiving mobile IPTV multicast service data is zero.

FIG. 3 is a flowchart illustrating a method of dynamically configuring a service area upon subscription to a mobile IPTV service according to an exemplary embodiment.

When a subscription request signal for a mobile IPTV service is received from the terminal 110, the service controller 140 determines whether or not the terminal 110 has subscribed to the mobile IPTV service on the basis of service profile information received from an authentication apparatus (e.g., AAA), and transmits a subscription response signal to the terminal 110 on the basis of the determination result (operation 310).

The terminal 110 measures an ambient electromagnetic wave environment based on a current location, and transmits a candidate member base station list selected on the basis of information on the measured ambient electromagnetic wave environment to the service controller 140. The service controller 140 receives the candidate member base station list from the terminal 110 (operation 312).

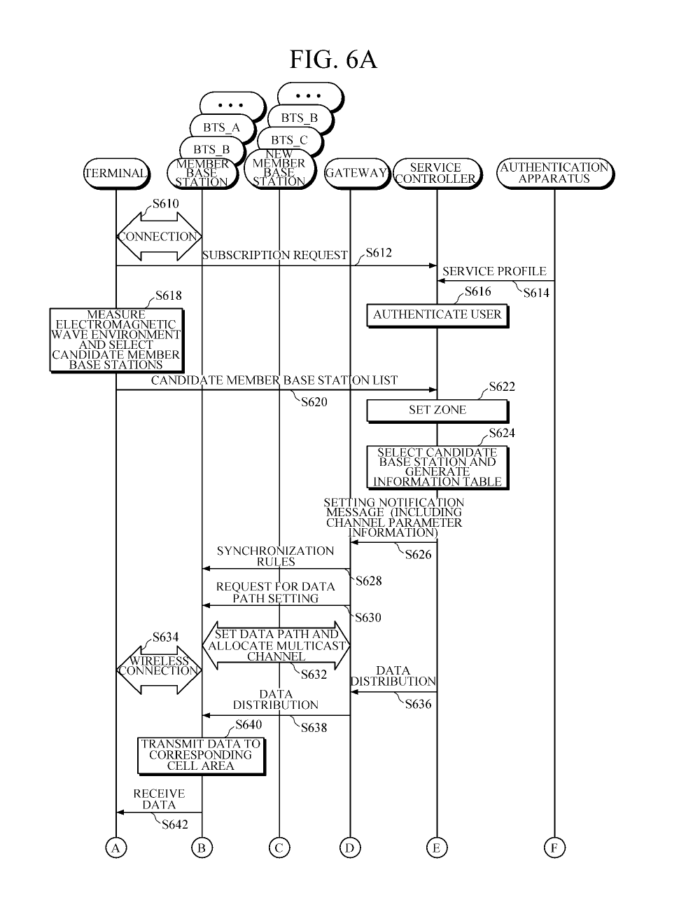

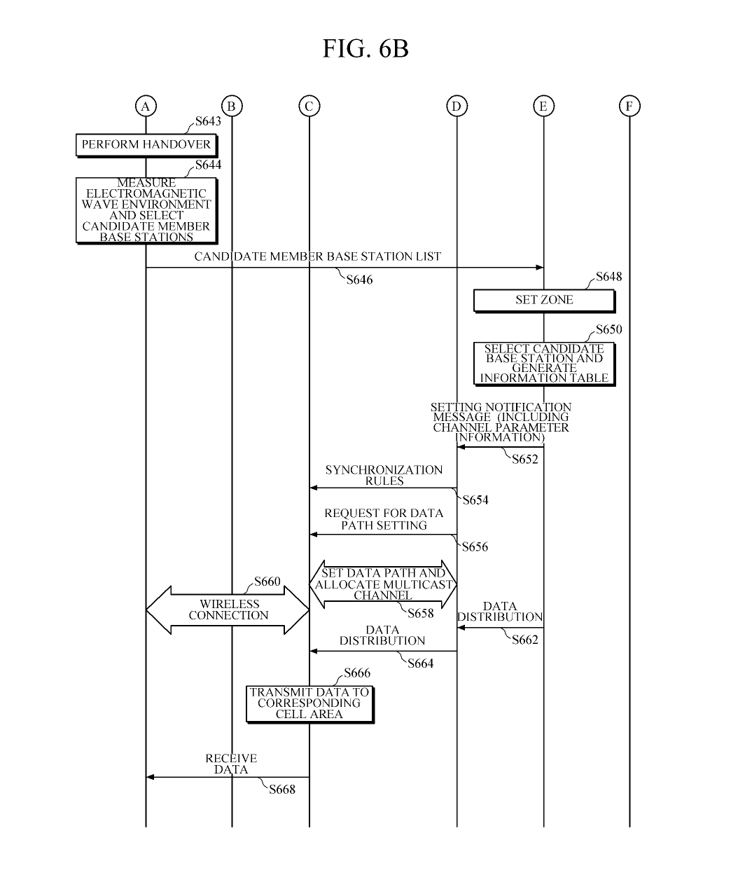

The service controller 140 checks whether or not the mobile IPTV service requested by the terminal 110 is being provided to the terminal 110 (operation 314). When it is checked in operation 314 that the mobile IPTV service requested by the terminal 110 is not being provided to the terminal 110, the service controller 140 generates a new service zone (operation 316). In other words, in operation 316, a new service zone is generated (set), and it is possible to modify the number of users of a member base station corresponding to each service zone. This operation 316 will be described in detail with reference to FIG. 6. Meanwhile, when it is checked in operation 314 that the mobile IPTV service requested by the terminal 110 is being provided to the terminal 110, the service controller 140 compares the candidate member base station list with a member base station list of a user setting zone (operation 320). Here, the member base station list of the user setting zone is a list of member base stations in a zone set by a user or administrator.

The service controller 140 checks whether or not the candidate member base station list has the same member base stations as the member base station list of the user setting zone (operation 322). When it is checked in operation 322 that the candidate member base station list has the same member base stations as the member base station list of the user setting zone, the service controller 140 maintains a previously set service zone (operation 324). On the other hand, when it is checked in operation 322 that the candidate member base station list does not have the same member base stations as the member base station list of the user setting zone, the service controller 140 extracts a base station included in the candidate member base station list only and a base station included in the member base station list of the user setting zone only (operation 330).

The service controller 140 checks whether or not all base stations that may be added as member base stations of a service zone are included as member base stations of the previously set service zone (operation 332). When it is checked in operation 332 that all the base stations that may be added as member base stations of the service zone are not included as member base stations of the previously set service zone, the service controller 140 generates a user setting zone from the candidate member base stations (operation 334).

The service controller 140 modifies the number of users on the basis of a currently provided mobile IPTV service (operation 336). Specifically, in operation 336, the service controller 140 may increase the number of users of each member base station newly added to the user setting zone by one, and reduce the number of users of each member base station excluded from the user setting zone by one. The service controller 140 checks whether or not the number of users of a member base station excluded from the user setting zone becomes zero (operation 338). When it is checked in operation 338 that the number of users of a member base station excluded from the user setting zone becomes zero, the service controller 140 excludes the candidate member base stations from member base stations of the corresponding service zone (operation 340). The service controller 140 changes the constitution of the service zone (operation 342).

FIG. 3 illustrates that operations 310 to 342 are sequentially performed, but this is merely an example of the spirit of this exemplary embodiment. Since those of ordinary skill in the art will be able to change the sequence illustrated in FIG. 3 and perform the operations 310 to 342, or diversely modify the sequence and perform at least one operation of the operations 310 to 342 in parallel, without departing from the basic spirit of this exemplary embodiment, FIG. 3 is not limited to the time-series sequence.

FIG. 4 is a flowchart illustrating a method of dynamically configuring a service area upon withdrawal from a mobile IPTV service according to an exemplary embodiment.

The service controller 140 receives a signal requesting withdrawal from a mobile IPTV service from the terminal 110 (operation 410). The service controller 140 searches for information on a user setting zone (operation 420), and reduces the number of users of each member base station included in the user setting zone by one (operation 430). The service controller 140 checks whether or not the number of mobile IPTV service users of a member base station in a service zone is zero (operation 440). When it is checked in operation 440 that the number of mobile IPTV service users of a member base station in the service zone is zero, the service controller 140 changes the constitution of the service zone (operation 450). Specifically, the service controller 140 excludes the base station from member base station of the service zone. Meanwhile, when it is checked in operation 440 that the number of mobile IPTV service users of a member base station in the service zone is not zero, the service controller 140 maintains the constitution of the service zone (operation 460).

FIG. 4 illustrates that operations 410 to 460 are sequentially performed, but this is merely an example of the spirit of this exemplary embodiment. Since those of ordinary skill in the art will be able to change the sequence illustrated in FIG. 4 and perform the operations 410 to 460, or diversely modify the sequence and perform at least one of operations 410 to 460 in parallel, without departing from the basic spirit of this exemplary embodiment, FIG. 4 is not limited to the time-series sequence.

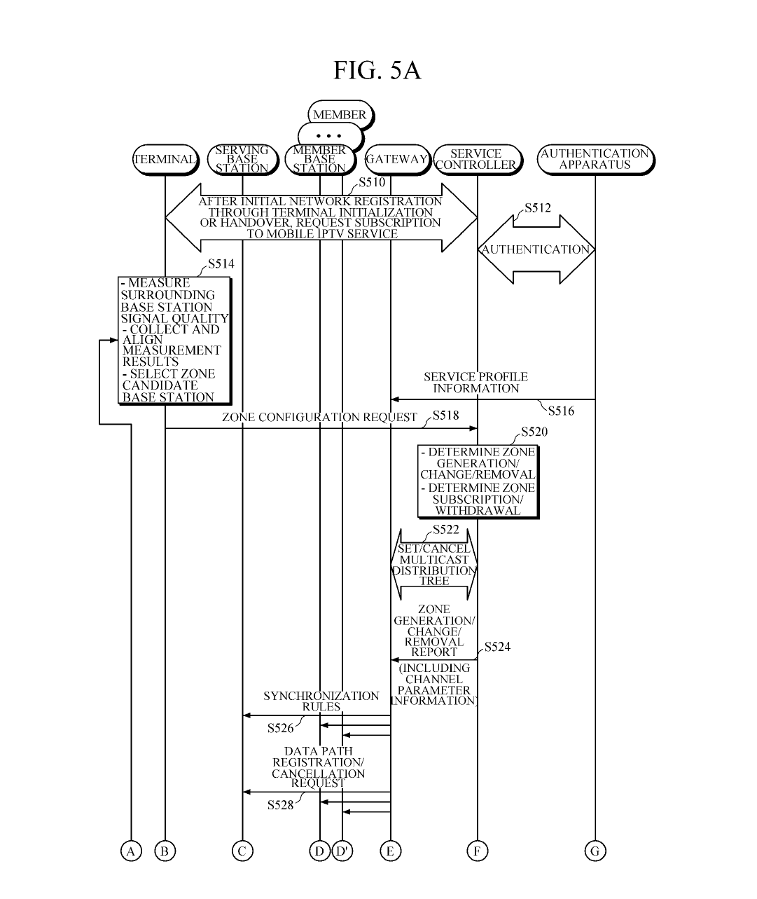

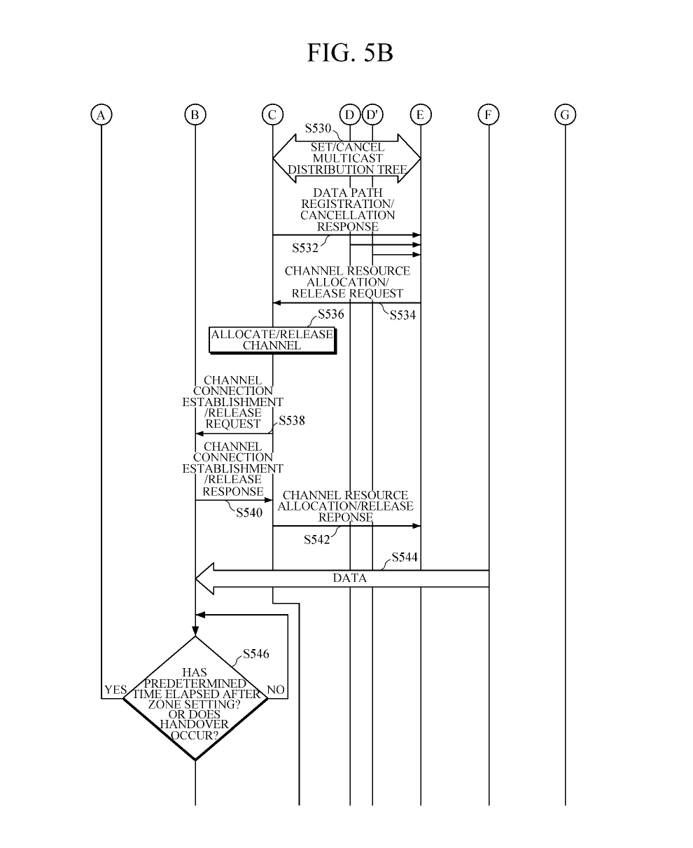

FIG. 5 is a flowchart illustrating configuration, change and release of a mobile IPTV service area according to an exemplary embodiment.

After initial network registration through initialization or a handover, the terminal 110 transmits an initial mobile IPTV service subscription request signal to the service controller 140 to use a mobile IPTV service (operation 510). The service controller 140 interoperates with an authentication apparatus (e.g., AAA) to approve subscription of the terminal having transmitted the mobile IPTV service subscription request signal (operation 512). The terminal 110 measures an ambient electromagnetic wave environment on the basis of a current location, and selects a candidate member base station list on the basis of information on the measured ambient electromagnetic wave environment (operation 514).

The authentication apparatus (e.g., AAA) transmits service profile information on the terminal 110 to the service controller 140 via the gateway 130 (operation 516). Specifically, in operation 516, the service controller 140 may receive the subscription request signal for the mobile IPTV service from the terminal 110, determine whether or not the terminal 110 has subscribed to the mobile IPTV service on the basis of the service profile information received from the authentication apparatus, and transmit a subscription response signal to the terminal on the basis of the determination result.

The terminal 110 transmits the selected candidate member base station list to the service controller 140 and requests configuration of a service zone (operation 518). The service controller 140 determines a service zone on the basis of a candidate member base station list received from the terminal 110 (operation 520). In operation 520, the service controller 140 determines generation, change or removal of the service zone, as well as joining or leaving of the service zone.

The service controller 140 performs multicast distribution with the gateway 130 (operation 522), and transfers generation information on the service zone to the gateway 130 (operation 524). The gateway 130 transmits a synchronization rule message to a member base station corresponding to the service zone (operation 526), and transmits a message for a data path setting request (operation 528). Between the member base station and the gateway 130, multicast distribution is performed (operation 530), data paths are set (operation 532), and allocation of channel resources is requested (operation 534). When a channel is allocated according to the corresponding channel resources (operation 536), the member base station sets a channel connection with the terminal 110 (operation 538), and transmits a channel connection setting response message to the member base station (operation 540).

The member base station transmits a channel resource allocation response message to the gateway 130 (operation 542). When the gateway 130 notifies the service controller 140 that allocation of resources between the terminal 110 and the gateway 130 is complete, the service controller 140 transmits data to the terminal via the gateway 130 and the member base station (operation 544). When a predetermined time elapses or a handover occurs, the terminal 110 may perform operations 514 to 544 again (operation 546).

FIG. 5 illustrates that operations 510 to 546 are sequentially performed, but this is merely an example of the spirit of this exemplary embodiment. Since those of ordinary skill in the art will be able to change the sequence illustrated in FIG. 5 and perform the operations 510 to 546, or diversely modify the sequence and perform at least one operation of the operations 510 to 546 in parallel, without departing from the basic spirit of this exemplary embodiment, FIG. 5 is not limited to the time-series sequence.

FIG. 6 is a flowchart illustrating a method of selecting a base station to dynamically configure a mobile IPTV service area according to an exemplary embodiment.

The terminal 110 connects to a mobile network through base station B 122 (operation 610), and transmits a subscription request signal for a mobile IPTV service to the service controller 140 (operation 612). When the subscription request signal for the mobile IPTV service is received from the terminal 110, the service controller 140 receives service profile information from an authentication apparatus (e.g., AAA) (operation 614), determines whether or not the terminal 110 has subscribed to the mobile IPTV service on the basis of the received service profile information, and transmits a subscription response signal to the terminal 110 on the basis of the determination result (operation 616).

The terminal 110 measures an ambient electromagnetic wave environment on the basis of a current location, selects a candidate member base station list on the basis of information on the measured ambient electromagnetic wave environment (operation 618), and transmits the selected candidate member base station list to the service controller 140 (operation 620). The service controller 140 generates a service area of zone A on the basis of the selected candidate member base station list and predetermined information (operation 622). Since the terminal 110 has been connected through base station B 122 in operation 622, the service controller 140 may generate the service area of zone A including base station A 120 and base station B 122.

The service controller selects an optimum candidate base station from the candidate member base station list, and generates an information table for managing zone A (operation 624). In operation 624, the information table includes at least one kind of information among identifier information on zone A, identifier information on member base stations of zone A, user identifier information, and channel parameter information used in zone A. The service controller 140 transmits a new setting notification message about zone A to the gateway 130 (operation 626). Here, the new setting notification message includes at least one kind of information among identifiers of the member base stations of zone A and channel parameter information for transferring data in a zone.

When the new setting notification message is received, the gateway 130 transmits a message about synchronization rules to the member base stations (base station A 120 and base station B 122) of zone A corresponding to the new notification message (operation 628), and transmits a message for a data path setting request to the member base stations of zone A (operation 630), thereby setting data paths with the member base stations (base station A 120 and base station B 122) and allocating multicast channels according to the synchronization rules (operation 632). The member base stations (base station A 120 and base station B 122) are wirelessly connected with the terminal 110 (operation 634).

The service controller 140 distributes mobile IPTV multicast service data to the gateway 130 (operation 636). When the mobile IPTV multicast service data is received through the gateway 130, the mobile IPTV multicast service data is distributed to the respective member base stations (base station A 120 and base station B 122) of zone A (operation 638), and transmitted to the corresponding cell area through the member base stations (operation 640). The terminal 110 receives the mobile IPTV multicast service data from all the base stations (base station A 120 and base station B 122) corresponding to the member base stations of zone A (operation 642).

When the terminal 110 changes a wireless access point from base station B 122 to base station C 124 while utilizing the mobile IPTV service, the terminal 110 performs a handover (operation 643). In operation 643, base station C 124 transmits a movement report signal of the terminal 110 to the service controller 140.

The terminal 110 measures an ambient electromagnetic wave environment on the basis of a current location, selects a candidate member base station list on the basis of information on the measured ambient electromagnetic wave environment (operation 644), and transmits the selected candidate member base station list to the service controller 140 (operation 646). The service controller 140 generates a service area of zone B on the basis of the selected candidate member base station list and the predetermined information (operation 648). Since the terminal 110 has moved to base station C 124 in operation 648, the service controller 140 may generate the service area of zone B including base station B 122 and base station C 124. In other words, while receiving a movement report signal of the terminal 110 that is utilizing the mobile IPTV service, the service controller 140 configures a new service area by replacing zone A, which is the previous service area, with the service area of zone B according to a report message, and then transmits mobile IPTV multicast service data to zone B, the new service area.

The service controller 140 selects an optimum candidate base station from the candidate member base station list, and generates an information table for managing zone B (operation 650). In operation 650, the information table includes at least one kind of information among identifier information on zone B, identifier information on member base stations of zone B, the user identifier information, and channel parameter information used in zone B. Also, in operation 650, the service controller 140 compares the ambient electromagnetic wave environment information received from the terminal 110 which has changed the wireless access point with the candidate member base station list received from the terminal 110, and adds a new member base station to the information table or excludes a member base station that is not included in the candidate member base station list from the information table. The service controller 140 transmits a new setting notification message about zone B to the gateway 130 (operation 652). Here, the new setting notification message includes at least one kind of information among identifiers of the member base stations of zone B and channel parameter information for transferring data in a zone.

When the new setting notification message is received, the gateway 130 transmits a message about synchronization rules to the member base stations of zone B (base station C 124 and base station B 122) corresponding to the new notification message (operation 654), transmits a message for a data path setting request to the member base stations of zone B (operation 656), thereby setting data paths with the member base stations (base station C 124 and base station B 122) and allocating multicast channels according to the synchronization rules (operation 658).

The member base stations (base station C 124 and base station B 122) are wirelessly connected with the terminal 110 (operation 660). The service controller 140 distributes mobile IPTV multicast service data to the gateway 130 (operation 662). When the mobile IPTV multicast service data is received through the gateway 130, the mobile IPTV multicast service data is distributed to the respective member base stations (base station C 124 and base station B 122) of zone B (operation 664), and transmitted to the corresponding cell area through the member base stations (operation 666). The terminal 110 receives the mobile IPTV multicast service data from all the base stations (base station C 124 and base station B 122) corresponding to the member base stations of zone B (operation 668).

FIG. 6 illustrates that operations 610 to 668 are sequentially performed, but this is merely an example of the spirit of this exemplary embodiment. Since those of ordinary skill in the art will be able to change the sequence illustrated in FIG. 6 and perform the operations 610 to 668, or diversely modify the sequence and perform at least one operation of the operations 610 to 668 in parallel, without departing from the basic spirit of this exemplary embodiment, FIG. 6 is not limited to the time-series sequence.

The method of selecting a base station to dynamically configure a mobile IPTV service area according to this exemplary embodiment illustrated in FIG. 6 can be implemented as a program and recorded in a computer-readable recording medium. The computer-readable recording medium in which the program for implementing the method of selecting a base station to dynamically configure a mobile IPTV service area according to this exemplary embodiment is recorded includes all types of recording media in which computer readable data is stored. Examples of the computer-readable recording medium include a ROM, a RAM, a CD-ROM, a magnetic tape, a floppy disk, and an optical data storage. Further, the recording medium may be implemented in the form of carrier waves (e.g., Internet transmission). In addition, the computer-readable recording medium may be distributed among computer systems over a network, in which computer-readable codes may be stored and executed in a distributed manner. Functional programs, codes, and code segments for accomplishing the present invention can be easily inferred by programmers in the art to which the present invention pertains.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method of selecting a base station to dynamically configure a mobile Internet protocol television (IPTV) service area in a mobile communication system, comprising:
a connection process of connecting, at a terminal, to a mobile network through a second base station, transmitting a mobile IPTV service request signal to a service controller, and establishing a multicast connection to the second base station;
a multicasting process of generating, at the service controller, a service area of a first zone including a first base station and the second base station and transmitting mobile IPTV multicast service data to the terminal, receiving, at the terminal, the mobile IPTV multicast service data through the first base station as well as the second base station, which are member base stations of the first zone, and multicasting, at the member base stations of the first zone, the data to the terminal;
a terminal movement checking process of, when the terminal changes a wireless access point from the second base station to a third base station while utilizing a mobile IPTV service, transmitting, at the third base station, a movement report signal of the terminal to the service controller;
a service area reconfiguration process of configuring, at the service controller, a new service area by replacing the first zone that is the previous service area with a service area of a second zone according to a report message while receiving the movement report signal of the terminal that is utilizing the mobile IPTV service, and transmitting the mobile IPTV multicast service data to the second zone that is the new service area; and
a data receiving process of simultaneously receiving, at the terminal, the mobile IPTV multicast service data through the second base station and the third base station.

2. The method of claim 1, wherein member base stations of the second zone include the second base station and the third base station.

3. The method of claim 1, further comprising, when a subscription request signal for the mobile IPTV service is received from the terminal before the connection process, determining, at the service controller, whether or not the terminal has subscribed to the mobile IPTV service on the basis of service profile information received from an authentication apparatus, and transmitting a subscription response signal to the terminal on the basis of the determination result.

4. The method of claim 1, wherein in the multicasting process, the terminal measures an ambient electromagnetic wave environment and transmits a candidate member base station list selected on the basis of information on the measured ambient electromagnetic wave environment to the service controller.

5. The method of claim 4, wherein in the multicasting process, the service controller selects the first zone that is the service area on the basis of the candidate member base station list and predetermined reference information.

6. The method of claim 5, wherein in the multicasting process, the service controller selects an optimum candidate base station from the candidate member base station list and generates an information table for managing the first zone.

7. The method of claim 6, wherein the information table includes at least one kind of information among identifier information on the first zone, identifier information on member base stations, user identifier information, and channel parameter information used in the first zone.

8. The method of claim 7, wherein in the multicasting process, the service controller transmits a new setting notification message about the first zone to a gateway.

9. The method of claim 8, wherein the new setting notification message includes at least one kind of information among identifiers of the member base stations of the first zone and channel parameter information for transferring data in the zone.

10. The method of claim 8, wherein, when the new setting notification message is received in the multicasting process, the gateway transmits a message about synchronization rules and a message for a data path setting request to the member base stations of the first zone corresponding to the new setting notification message to set data paths with the member base stations and allocate multicast channels according to the synchronization rules.

11. The method of claim 10, wherein in the multicasting process, the service controller distributes the mobile IPTV multicast service data to the gateway, and
when the mobile IPTV multicast service data is received through the gateway, the mobile IPTV multicast service data is distributed to the respective member base stations of the first zone and transmitted to the corresponding cell area through the member base stations.

12. The method of claim 11, wherein in the multicasting process, the terminal receives the mobile IPTV multicast service data from all base stations corresponding to the member base stations of the first zone.

13. The method of claim 1, wherein in the service area reconfiguration process, the service controller compares ambient electromagnetic wave environment information received from the terminal that has changed the wireless access point with a candidate member base station list received from the terminal, and
adds a new member base station to an information table or excludes a member base station that is not included in the candidate member base station list from the information table.

14. The method of claim 13, wherein in the service area reconfiguration process, the service controller transmits a new setting notification message about the second zone to a gateway.

15. A system for selecting a base station to dynamically configure a mobile Internet protocol television (IPTV) service area in a mobile communication system, comprising:
a terminal configured to connect to a second base station and transmit a mobile IPTV service request signal; and
a service controller configured to generate a service area of a first zone including the second base station and a first base station as member base stations, transmit mobile IPTV multicast service data corresponding to the mobile IPTV service request signal to the terminal through the member base stations of the first zone, and when a movement report signal of the terminal that is receiving the mobile IPTV multicast service data is received from a third base station, configure a new service area by replacing the first zone with a service area of a second zone including the second base station and the third base station as member base stations, and transmit the mobile IPTV multicast service data to the terminal through the member base stations of the second zone.

16. The system of claim 15, wherein the service controller determines whether or not to maintain the first zone on the basis of a number of terminals that are connected to the second base station and receiving the mobile IPTV multicast service data.

17. The system of claim 16, wherein the service controller maintains the first zone when the number of terminals that are connected to the second base station and receiving the mobile IPTV multicast service data is not zero.

18. An apparatus for dynamically configuring a service area, comprising:
a signal receiver configured to receive a mobile Internet protocol television (IPTV) service request signal from a terminal connected to a second base station;
a service area setter configured to generate a service area of a first zone including the second base station and a first base station as member base stations, and cause mobile IPTV multicast service data corresponding to the mobile IPTV service request signal to be transmitted to the terminal through the member base stations of the first zone;
a mobility determiner configured to receive a movement report signal of the terminal that is receiving the mobile IPTV multicast service data from a third base station; and
a service area reconfigurator configured to, when the movement report signal is received, configure a new service area by replacing the first zone with a service area of a second zone including the second base station and the third base station as member base stations, and cause the mobile IPTV multicast service data to be transmitted to the terminal through the member base stations of the second zone.

19. The apparatus of claim 18, further comprising a service area maintenance determiner configured to determine whether or not to maintain the first zone on the basis of a number of terminals that are connected to the second base station and receiving the mobile IPTV multicast service data.

20. The apparatus of claim 19, wherein the service area maintenance determiner maintains the first zone when the number of terminals that are connected to the second base station and receiving the mobile IPTV multicast service data is not zero.
